(19) United States
(12) Patent Application Publication
(10) Pub. No.: US 2026/0161213 A1
(43) Pub. Date: Jun. 11, 2026

(54) ELECTRONIC APPARATUS AND CONTROL METHOD FOR ELECTRONIC APPARATUS

(71) Applicant: Lenovo (Singapore) Pte. Ltd., Singapore (SG)

(72) Inventors: Seiji Yamasaki, Kanagawa (JP); Osamu Ohsawa, Kanagawa (JP); Koutaroh Maki, Kanagawa (JP)

(73) Assignee: Lenovo (Singapore) Pte. Ltd., Singapore (SG)

(21) Appl. No.: 19/179,517

(22) Filed: Apr. 15, 2025

(30) Foreign Application Priority Data
Apr. 23, 2024 (JP) 2024-069786

(51) Int. Cl. G06F 1/324

(52) U.S. Cl. CPC G06F 1/324

(57) ABSTRACT

An electronic apparatus includes a connector to which an external apparatus is connected and which is configured to output electric power supplied from a battery to the external apparatus; and a controller. The controller changes a first reference value determined in advance by an OS to a second reference value larger than the first reference value, as a decrease of a residual amount of the battery from a first timing when the electronic apparatus shifts from an operating state to a sleep state with the external apparatus being connected to the connector until a second timing when the electronic apparatus shifts from the sleep state to an idle state with the external apparatus being connected to the connector. When the decrease of the residual amount of the battery from the first timing becomes the second reference value, the controller shifts the electronic apparatus to the idle state.

### CROSS-REFERENCE TO RELATED APPLICATIONS

This application claims priority to Japanese Patent Application No. 2024-069786 filed on Apr. 23, 2024, the contents of which are hereby incorporated herein by reference in their entirety.

### TECHNICAL FIELD

The present invention relates to an electronic apparatus and a control method for the electronic apparatus.

### BACKGROUND

One of the standards for management of a power source of a computer is ACPI (Advanced Configuration and Power Interface) (for example, see Japanese Unexamined Patent Application Publication No. 2023-047293). In ACPI, power states (from S0 to S5) of an apparatus are defined. General power states defined in ACPI are as follows. A computer is in an operating state in S0, and the computer is in a standby state in S1 and S2. The computer is in a sleep state in S3, and the computer is in an idle state in S4. The computer is in a shutdown state in S5. A function called modern standby (hereinafter referred to as ModS) may be implemented as a sleep state in the computer.

In a case where a function called AOU (Always on USB) is implemented in the computer, the computer can supply electric power to an external apparatus such as a smartphone via a USB (Universal Serial Bus) from a battery provided for the computer.

When the residual amount of the battery becomes smaller than a predetermined amount during power feeding of the computer to an external apparatus in S4 or S5, the computer stops power supply by AOU to avoid a decrease in the residual amount of the battery. In S4 and S5, the power supply from the battery to an embedded controller of the computer does not stop. Accordingly, in the computer in which the embedded controller monitors the state of the battery, the embedded controller can detect the residual amount of the battery in S4 and S5, so that AOU can be continued until the residual amount of the battery becomes smaller than the predetermined amount.

However, in S4 and S5, power supply from the battery to a CPU (Central Processing Unit) of the computer stops. In the computer in which the CPU monitors the state of the battery, the CPU cannot detect the residual amount of the battery in S4 and S5. On this account, such a computer cannot perform power supply by AOU in S4 and S5.

The amount of electric power suppliable by the battery in ModS is set by an OS (Operating System). For example, the amount of electric power is 5% of the capacity of the battery. When the consuming amount of the battery in ModS becomes 5%, the computer shifts from ModS to S4. Since the amount of electric power feedable by the battery in ModS is small, electric power suppliable by AOU is restricted in the computer in which the CPU monitors the state of the battery.

### SUMMARY

Embodiments of the present disclosure provide an electronic apparatus and a control method for the electronic apparatus each of which can increase the amount of electric power to be supplied from a battery to an external apparatus in a sleep state.

An electronic apparatus according to one aspect of the present invention includes: a connector to which an external apparatus is connected and which is configured to output electric power supplied from a battery to the external apparatus; and a controller. The controller changes a first reference value determined in advance by an OS (Operating System) to a second reference value larger than the first reference value, as a decrease of a residual amount of the battery from a first timing when the electronic apparatus shifts from an operating state to a sleep state with the external apparatus being connected to the connector until a second timing when the electronic apparatus shifts from the sleep state to an idle state with the external apparatus being connected to the connector, and when the decrease of the residual amount of the battery from the first timing becomes the second reference value, the controller shifts the electronic apparatus to the idle state.

In the one aspect of the present invention, the electronic apparatus may further include: a memory configured to store a third reference value indicative of a residual amount of the battery at a time when output of the electric power to the external apparatus is stopped in an operation mode in which the electric power is output to the external apparatus with the electronic apparatus being in the operating state or in the sleep state. The controller may detect a fourth reference value that is a residual amount of the battery at a time when the electronic apparatus is shifted from the operating state to the sleep state. The fourth reference value may be larger than the third reference value. The controller may calculate the second reference value by calculating a difference between the fourth reference value and the third reference value. When the residual amount of the battery in the operation mode decreases and becomes the third reference value after the first reference value is changed to the second reference value, the controller may stop output of the electric power to the external apparatus.

In the one aspect of the present invention, in a case where the external apparatus is a media transfer protocol (MTP) device, the controller may change the first reference value to the second reference value.

A control method according to another aspect of the present invention is a control method for controlling an electronic apparatus including a connector to which an external apparatus is connected and which is configured to output electric power supplied from a battery to the external apparatus, and the control method includes: a step of changing a first reference value determined in advance by an OS (Operating System) to a second reference value larger than the first reference value, as a decrease of a residual amount of the battery from a first timing when the electronic apparatus shifts from an operating state to a sleep state with the external apparatus being connected to the connector until a second timing when the electronic apparatus shifts from the sleep state to an idle state with the external apparatus being connected to the connector; and a step of shifting the electronic apparatus to the idle state when the decrease of the residual amount of the battery from the first timing becomes the second reference value.

One or more embodiments of the present invention can increase the amount of electric power to be supplied from the battery to the external apparatus in a sleep state.

### BRIEF DESCRIPTION OF THE DRAWINGS

FIG. 1 is a view illustrating an exemplary hardware configuration of an electronic apparatus according to one or more embodiments;

FIG. 2 is a view illustrating an exemplary functional configuration of the electronic apparatus according to one or more embodiments;

FIG. 3 is a view illustrating a power state of the electronic apparatus according to one or more embodiments; and

FIG. 4 is a flowchart illustrating an example of the operation of the electronic apparatus according to one or more embodiments.

### DETAILED DESCRIPTION

With reference to the drawings, the following describes embodiments of the present invention.

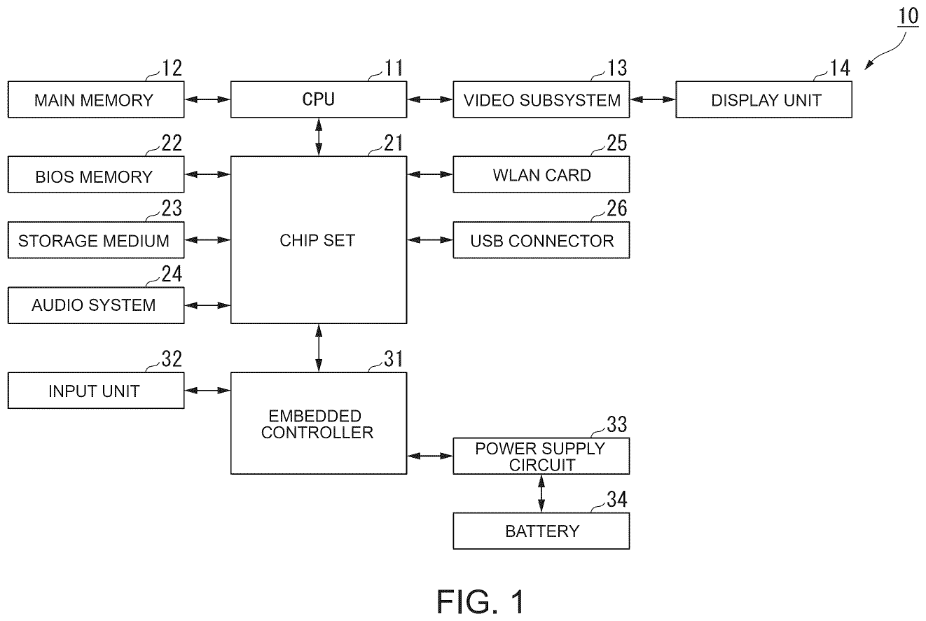

An exemplary hardware configuration of an electronic apparatus 10 according to one or more embodiments will be described with reference to FIG. 1. FIG. 1 is a block diagram illustrating the exemplary hardware configuration of the electronic apparatus 10.

The electronic apparatus 10 includes a CPU 11, a main memory 12, a video subsystem 13, a display unit 14, a chip set 21, a BIOS memory 22, a storage medium 23, an audio system 24, a WLAN card 25, a USB connector 26, an embedded controller 31, an input unit 32, a power supply circuit 33, and a battery 34.

The CPU 11 executes various arithmetic processes by a program control and controls the whole electronic apparatus 10. For example, the CPU 11 executes a process based on programs of an OS (Operating System) and a BIOS (Basic Input Output System). The CPU 11 is an example of a processor.

The main memory 12 is a writable memory used as a read-in area for an execution program to be executed by the CPU 11 or a work area in which processing data of the execution program is written. The main memory 12 is constituted by a plurality of DRAM (Dynamic Random Access Memory) chips, for example. The execution program includes the OS, various drivers for operating peripheral devices by hardware, various services and utilities, an application program, and so on.

The video subsystem 13 is a subsystem for achieving a function related to image display and includes a video controller. The video controller processes a drawing command from the CPU 11, writes processed drawing information in a video memory, and reads the drawing information from the video memory, and outputs the drawing information to the display unit 14 as drawing data (display data).

The display unit 14 is a liquid crystal display or an organic EL display, for example, and displays a display screen based on the drawing data (display data) output from the video subsystem 13.

The chip set 21 includes controllers for a USB (Universal Serial Bus), serial ATA (AT Attachment), an SPI (Serial Peripheral Interface) bus, a PCI (Peripheral Component Interconnect) bus, a PCI-Express bus, an LPC (Low Pin Count) bus, and the like, and a plurality of devices is connected to the chip set 21. The plurality of devices includes, for example, the BIOS memory 22, the storage medium 23, the audio system 24, the WLAN card 25, the USB connector 26, and the embedded controller 31 (described later).

The BIOS memory 22 is constituted by an electrically rewritable nonvolatile memory such as an EEPROM (Electrically Erasable Programmable Read Only Memory) or a flash ROM, for example. The BIOS memory 22 stores the BIOS, system firmware for controlling the embedded controller 31 or the like, and so on. The BIOS memory 22 is an example of a sub-memory.

The storage medium 23 includes an HDD (Hard Disk Drive), an SSD (Solid State Drive), and the like. The storage medium 23 stores, for example, the OS, various drivers, various services and utilities, an application program, and various types of data.

A microphone and a speaker (not illustrated) are connected to the audio system 24 such that the audio system 24 records, plays, and outputs audio data. Note that the microphone and the speaker are installed in the electronic apparatus 10 as one example.

The WLAN (Wireless Local Area Network) card 25 is connected to a network by a wireless LAN and performs data communication. At the time when the WLAN card 25 receives data from the network, for example, the WLAN card 25 generates an event trigger indicating that the data has received. The USB connector 26 is a connector to which a peripheral device using a USB is to be connected.

The input unit 32 collectively indicates input devices provided for the electronic apparatus 10. The input unit 32 includes a keyboard, a mouse, and so on. The input unit 32 outputs input information input by an operation performed by a user to the embedded controller 31.

The power supply circuit 33 includes, for example, a DC/DC converter, a charging and discharging unit, an AC/DC adapter, and so on. For example, the power supply circuit 33 converts a direct-current voltage supplied from an external power source such as an AC adapter (not illustrated) or the battery 34 into a plurality of voltages necessary to operate the electronic apparatus 10. The power supply circuit 33 supplies electric power to various sections of the electronic apparatus 10 based on the control from the embedded controller 31.

The battery 34 is a secondary battery such as a lithium-ion battery, for example. When electric power is supplied to the electronic apparatus 10 from the external power source, the battery 34 is charged via the power supply circuit 33. When no electric power is supplied to from the external power source the electronic apparatus 10, the battery 34 outputs accumulated electric power as operating power for the electronic apparatus 10 via the power supply circuit 33.

The embedded controller 31 is a one-chip microcomputer configured to monitor and control various devices (peripheral devices, sensors, and the like) regardless of the system state of the electronic apparatus 10. The embedded controller 31 includes a CPU, a ROM, a RAM, A/D input terminals for a plurality of channels, a D/A output terminal, a timer, and a digital input-output terminal. The input unit 32, the power supply circuit 33, and the like are connected to the digital input-output terminal of the embedded controller 31, and the embedded controller 31 controls the operations of them. The embedded controller 31 also controls changes of the clock frequency of the CPU 11, and the like, via the chip set 21.

The electronic apparatus 10 may be configured such that a display device is integrally attached to a chassis like a portable device such as a clamshell-type personal computer, a tablet terminal, or a smartphone. Alternatively, the electronic apparatus 10 may be configured such that an apparatus main body is separated from a display device like a desktop personal computer. The electronic apparatus according to one or more embodiments is widely applicable to apparatuses including a CPU.

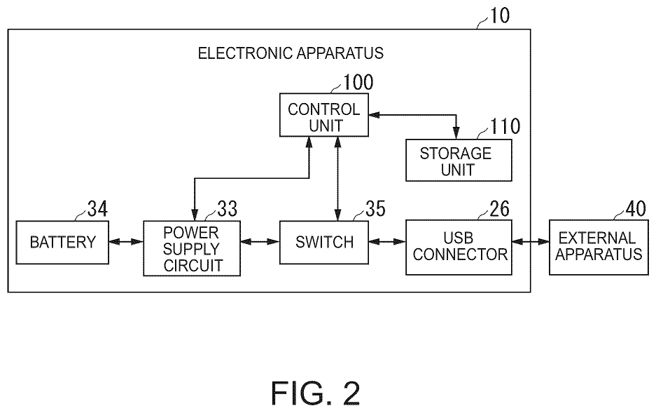

With reference to FIG. 2, the following describes an exemplary functional configuration of the electronic apparatus 10. FIG. 2 is a block diagram illustrating an example of the functional configuration of the electronic apparatus 10 which functional configuration is related to power supply to the external apparatus.

The electronic apparatus 10 includes a control unit 100, a storage unit 110, the USB connector 26, the power supply circuit 33, the battery 34, and a switch 35. The functions of the control unit 100 are implemented by the CPU 11, the embedded controller 31, or a combination of the CPU 11 and the embedded controller 31.

The storage unit 110 stores a program by the control unit 100, data used by the control unit 100, data generated by the control unit 100, and so on. The function of the storage unit 110 is implemented by the main memory 12, the storage medium 23, or a combination of the main memory 12 and the storage medium 23.

An external apparatus 40 is connected to the USB connector 26. In a case where no electric power is supplied from the external power source to the electronic apparatus 10, and the external apparatus 40 is connected to the USB connector 26, the control unit 100 controls power supply from the battery 34 to the external apparatus 40. The power supply circuit 33 outputs electric power output from the battery 34 to the switch 35. The switch 35 outputs electric power output from the power supply circuit 33 to the external apparatus 40 via the USB connector 26.

The control unit 100 controls a power state of the electronic apparatus 10 in response to a residual amount of the battery 34. The electronic apparatus 10 has a function of AOU for outputting electric power from the battery 34 to the external apparatus 40 in S0 (an operating state) or in ModS (a sleep state). The control unit 100 controls power supply from the battery 34 to the external apparatus 40 by controlling the state of the switch 35. When the electronic apparatus 10 is in S0 (the operating state) or ModS (the sleep state), the control unit 100 turns on the switch 35 and performs power supply from the battery 34 to the external apparatus 40 by AOU. When the electronic apparatus 10 shifts from ModS to S4 (an idle state), the control unit 100 turns off the switch 35 and stops power supply by AOU.

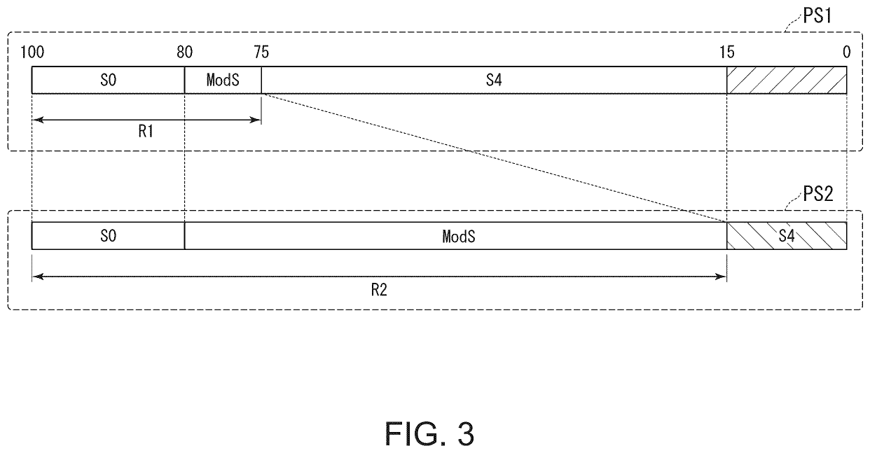

With reference to FIG. 3, changes in the power state of the electronic apparatus 10 will be described. FIG. 3 schematically illustrates the power state of the electronic apparatus 10. The power state corresponding to the residual amount of the battery 34 is illustrated in FIG. 3.

A state PS1 indicates a power state of the electronic apparatus 10 in a case where it is assumed that the control unit 100 executes a control in the related art. A state PS2 indicates a power state of the electronic apparatus 10 in a case where the control unit 100 executes the control in one or more embodiments.

The lateral direction in FIG. 3 corresponds to the residual amount of the battery 34. For example, the residual amount of the battery 34 is expressed as RSOC (Relative State of Charge). The RSOC is the ratio (RM/FCC) of a remaining capacity RM (Remaining Capacity) of the battery 34 to a full charge capacity FCC (Full Charge Capacity) of the battery 34.

First described is the state PS1. When the RSOC is 100% in the state PS1, the electronic apparatus 10 is in S0. At this time, power supply by AOU is performable. When a predetermined event occurs in the state PS1, the control unit 100 shifts the electronic apparatus 10 from S0 to ModS. For example, in a case where the electronic apparatus 10 is a clamshell-type personal computer, when a user closes its cover, the event occurs. Alternatively, the event occurs when the user presses a power button. For example, the RSOC is 80% when the event occurs. When a decrease of the RSOC in ModS in the state PS1 becomes a reference value (for example, 5% of FCC) determined in advance by the OS, the control unit 100 shifts the electronic apparatus 10 from ModS to S4.

In a case where the control unit 100 is constituted by the CPU 11, the control unit 100 is in the idle state in S4. Therefore, the control unit 100 cannot detect the residual amount of the battery 34. In the state PS1, when the electronic apparatus 10 shifts from ModS to S4, the control unit 100 stops power supply by AOU. In the state PS1, power supply by AOU is performable in a range R1 of the RSOC illustrated in FIG. 3.

Next will be described the state PS2. The OS determines a reference value (for example, 5% of FCC) for the decrease of the RSOC in ModS in advance. The reference value indicates a decrease of the residual amount of the battery 34 from the timing when the electronic apparatus 10 shifts from S0 to ModS until the timing when the electronic apparatus 10 shifts from ModS to S4. The storage unit 110 stores the reference value. The control unit 100 changes the reference value to a value larger than the reference value by changing standby budget assigned to ModS, for example.

The storage unit 110 stores a reference value (for example, 15%) for the RSOC when the electronic apparatus 10 stops power supply by AOU. When the electronic apparatus 10 shifts from S0 to ModS, the control unit 100 detects the residual amount of the battery 34. The control unit 100 changes the reference value for a decrease of the RSOC in ModS based on the detected residual amount and the reference value stored in the storage unit 110. For example, the control unit 100 calculates a difference between the detected residual amount (for example, 80%) and the reference value (for example, 15%) stored in the storage unit 110 and changes the reference value for the decrease of the RSOC in ModS to the value of the difference (for example, 65%).

When the RSOC is 100% in the state PS2, the electronic apparatus 10 is in S0. At this time, power supply by AOU is performable. When a predetermined event occurs in the state PS2, the control unit 100 shifts the electronic apparatus 10 from S0 to ModS. For example, the RSOC at this time is 80%.

When a decrease of the RSOC in ModS in the state PS2 becomes the reference value (for example, 65%) changed by the control unit 100, the control unit 100 shifts the electronic apparatus 10 from ModS to S4. At this time, the RSOC is the same as the reference value (for example, 15%) for the RSOC to stop power supply by AOU. Accordingly, the control unit 100 stops power supply by AOU. In the state PS2, power supply by AOU is performable in a range R2 of the RSOC illustrated in FIG. 3. The range R2 is larger than the range R1. That is, more electric power can be supplied to the external apparatus 40 by AOU in the state PS2 than in the state PS1.

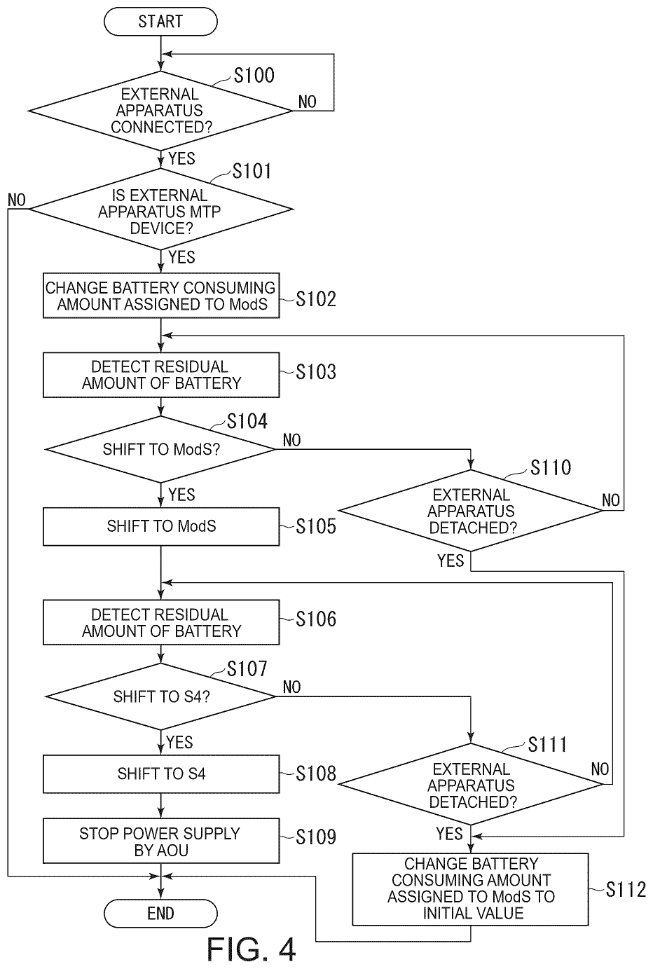

With reference to FIG. 4, the operation of the electronic apparatus 10 in the control of the power state will be described. FIG. 4 illustrates an example of a process executed by the electronic apparatus 10 to control the power state. The OS determines a reference value for the power state of the electronic apparatus 10 in advance. The storage unit 110 stores the reference value determined by the OS.

### Step S100

The control unit 100 monitors the state of the USB connector 26 and determines whether or not the external apparatus 40 is connected to the USB connector 26. In a case where the external apparatus 40 is not connected to the USB connector 26, the control unit 100 repeatedly performs the determination in step S100.

### Step S101

In a case where the external apparatus 40 is connected to the USB connector 26, the control unit 100 acquires information on the type of the external apparatus 40 from the external apparatus 40. The control unit 100 determines whether or not the external apparatus 40 is a media transfer protocol (MTP) device, based on the information. A smartphone, a tablet terminal, and the like are MTP devices. A human interface device (HID) such as a mouse or a keyboard is not an MTP device. In a case where the external apparatus 40 is not an MTP device, the process illustrated in FIG. 4 is ended. In this case, a control similar to the control in the related art is executed. Note that, in a case where the electronic apparatus 10 is in ModS with the external apparatus 40 being connected to the USB connector 26, the control unit 100 shifts the electronic apparatus 10 from ModS to S0. Step S101 is executed in a state where the electronic apparatus 10 is in S0.

### Step S102

In a case where the external apparatus 40 is an MTP device, the control unit 100 reads, from the storage unit 110, a reference value (for example, 80%) for the residual amount of the battery 34 at the time when the electronic apparatus 10 shifts from S0 to ModS. The control unit 100 also reads, from the storage unit 110, a reference value for the residual amount (for example, 15%) of the battery 34 at the time when power supply by AOU is stopped. The control unit 100 calculates a difference (for example, 65%) between the two reference values. The control unit 100 changes, to the difference calculated as described above, an initial value (for example, 5%) of the reference value which initial value is determined in advance by the OS as a decrease of the residual amount of the battery 34 in ModS.

### Step S103

The control unit 100 detects a residual amount of the battery 34 in S0.

### Step S104

The control unit 100 determines whether or not the electronic apparatus 10 is to be shifted from S0 to ModS, by determining whether or not a predetermined event occurs.

### Step S110

In a case where the predetermined event does not occur, the control unit 100 determines that the electronic apparatus 10 is not to be shifted from S0 to ModS. The control unit 100 monitors the state of the USB connector 26 and determines whether or not the external apparatus 40 is detached from the USB connector 26. In a case where the external apparatus 40 is not detached from the USB connector 26, step S103 is executed.

### Step S105

In a case where the predetermined event occurs, the control unit 100 shifts the electronic apparatus 10 from S0 to ModS. The control unit 100 stores, in the storage unit 110, the residual amount of the battery 34 which residual amount is detected in step S103 as a reference value. The reference value indicates the residual amount of the battery 34 at the time when the electronic apparatus 10 shifts from S0 to ModS.

### Step S106

The control unit 100 detects a residual amount of the battery 34 in ModS.

### Step S107

The control unit 100 reads, from the storage unit 110, the reference value (for example, 80%) for the residual amount of the battery 34 at the time when the electronic apparatus 10 shifts from S0 to ModS. The control unit 100 calculates a decrease of the residual amount of the battery 34 in ModS by subtracting, from the reference value, the residual amount of the battery 34 which residual amount is detected in step S106. The control unit 100 reads, from the storage unit 110, the reference value (for example, 65%) for the decrease of the residual amount of the battery 34 in ModS. The control unit 100 compares the calculated decrease with the reference value and determines whether or not the electronic apparatus 10 is to be shifted from ModS to S4.

### Step S111

In a case where the decrease of the residual amount of the battery 34 in ModS is smaller than the reference value, the control unit 100 determines that the electronic apparatus 10 is not shifted from ModS to S4. The control unit 100 monitors the state of the USB connector 26 and determines whether or not the external apparatus 40 is detached from the USB connector 26. In a case where the external apparatus 40 is not detached from the USB connector 26, step S106 is executed.

### Step S108

In a case where the decrease of the residual amount of the battery 34 in ModS reaches the reference value, the control unit 100 shifts the electronic apparatus 10 from ModS to S4.

### Step S109

When the electronic apparatus 10 shifts from ModS to S4, the residual amount of the battery 34 is smaller than the reference value for the residual amount (for example, 15%) of the battery 34 at the time when power supply by AOU is stopped. Accordingly, the control unit 100 stops power supply by AOU.

The order to execute step S108 and step S109 may be different from the order described above. That is, step S108 may be executed after execution of step S109.

### Step S112

In a case where the external apparatus 40 is detached from the USB connector 26, the control unit 100 changes the reference value (for example, 65%) for the decrease of the residual amount of the battery 34 in ModS to the initial value (for example, 5%). After that, when the external apparatus 40 as an MTP device is connected to the USB connector 26, the reference value for the decrease of the residual amount of the battery 34 in ModS is changed in accordance with the process described above. In a case where the external apparatus 40 that is not an MTP device is connected to the USB connector 26, the reference value for the decrease of the residual amount of the battery 34 in ModS is not changed. In a case where the external apparatus 40 is not an MTP device, the consuming amount of the battery 34 in ModS is restricted.

As described above, the external apparatus 40 is connected to the USB connector 26, and the USB connector 26 outputs electric power supplied from the battery 34 to the external apparatus 40. The control unit 100 (a controller) changes a first reference value (for example, 5%) determined in advance by the OS to a second reference value (for example, 65%) larger than the first reference value, as a decrease of the residual amount of the battery 34 from a first timing when the electronic apparatus 10 shifts from S0 (the operating state) to ModS (the sleep state) with the external apparatus 40 being connected to the USB connector 26 until a second timing when the electronic apparatus 10 shifts from ModS to S4 (the idle state) with the external apparatus 40 being connected to the USB connector 26. When the decrease of the residual amount of the battery 34 from the first timing becomes the second reference value, the control unit 100 shifts the electronic apparatus 10 to S4. Hereby, the electronic apparatus 10 can increase the amount of electric power to be supplied from the battery 34 to the external apparatus 40 in the sleep state. The above operation is performable in either of a case where the control unit 100 is constituted by the CPU 11 and a case where the control unit 100 is constituted by the embedded controller 31.

The storage unit 110 (a memory) stores a third reference value (for example, 15%) indicative of a residual amount of the battery 34 at the time when output of electric power to the external apparatus 40 is stopped in an operation mode (AOU) in which electric power is output to the external apparatus 40 with the electronic apparatus 10 being in S0 or ModS. The control unit 100 detects a fourth reference value as a residual amount of the battery 34 at the time when the electronic apparatus 10 shifts from S0 to ModS. The fourth reference value is larger than the third reference value. The control unit 100 calculates the second reference value by calculating a difference between the fourth reference value and the third reference value. When the residual amount of the battery 34 in AOU decreases and becomes the third reference value after the first reference value is changed to the second reference value, the control unit 100 stops output of electric power to the external apparatus 40. Hereby, the electronic apparatus 10 can increase the amount of electric power to be supplied from the battery 34 to the external apparatus 40 by AOU.

In a case where the external apparatus 40 is an MTP device, the control unit 100 changes the first reference value to the second reference value. Hereby, the electronic apparatus 10 can increase the amount of electric power to be supplied from the battery 34 to the MTP device in the sleep state.

One or more embodiments of the present invention have been described above in detail with reference to drawings. Specific configurations are not limited to the above embodiments, and modifications in design or the like can be made without departing from the gist of the present invention.

### Description of Symbols

10 electronic apparatus
11 CPU
12 main memory
13 video subsystem
14 display unit
21 chip set
22 BIOS memory
23 storage medium
24 audio system
25 WLAN card
26 USB connector
31 embedded controller
32 input unit
33 power supply circuit
34 battery
35 switch
100 control unit
110 storage unit

What is claimed is:

1. An electronic apparatus comprising:
a connector to which an external apparatus is connected and which is configured to output electric power supplied from a battery to the external apparatus; and
a controller, wherein:
the controller changes a first reference value determined in advance by an OS (Operating System) to a second reference value larger than the first reference value, as a decrease of a residual amount of the battery from a first timing when the electronic apparatus shifts from an operating state to a sleep state with the external apparatus being connected to the connector until a second timing when the electronic apparatus shifts from the sleep state to an idle state with the external apparatus being connected to the connector; and
when the decrease of the residual amount of the battery from the first timing becomes the second reference value, the controller shifts the electronic apparatus to the idle state.

2. The electronic apparatus according to claim 1, further comprising:
a memory configured to store a third reference value indicative of a residual amount of the battery at a time when output of the electric power to the external apparatus is stopped in an operation mode in which the electric power is output to the external apparatus with the electronic apparatus being in the operating state or in the sleep state, wherein:
the controller detects a fourth reference value that is a residual amount of the battery at a time when the electronic apparatus is shifted from the operating state to the sleep state;
the fourth reference value is larger than the third reference value;
the controller calculates the second reference value by calculating a difference between the fourth reference value and the third reference value; and
when the residual amount of the battery in the operation mode decreases and becomes the third reference value after the first reference value is changed to the second reference value, the controller stops output of the electric power to the external apparatus.

3. The electronic apparatus according to claim 1, wherein the external apparatus is a media transfer protocol (MTP) device and the controller changes the first reference value to the second reference value.

4. A control method for controlling an electronic apparatus including a connector to which an external apparatus is connected and which is configured to output electric power supplied from a battery to the external apparatus, the control method comprising:
a step of changing a first reference value determined in advance by an OS (Operating System) to a second reference value larger than the first reference value, as a decrease of a residual amount of the battery from a first timing when the electronic apparatus shifts from an operating state to a sleep state with the external apparatus being connected to the connector until a second timing when the electronic apparatus shifts from the sleep state to an idle state with the external apparatus being connected to the connector; and
a step of shifting the electronic apparatus to the idle state when the decrease of the residual amount of the battery from the first timing becomes the second reference value.
